(19) United States
(12) Patent Application Publication
(10) Pub. No.: US 2020/0309154 A1
(43) Pub. Date: Oct. 1, 2020

(54) FLUID PUMP CONTROL UNIT

(71) Applicant: AISAN KOGYO KABUSHIKI KAISHA, Obu-shi (JP)

(72) Inventor: Mamoru YOSHIOKA, Nagoya-shi (JP)

(73) Assignee: AISAN KOGYO KABUSHIKI KAISHA, Obu-shi (JP)

(21) Appl. No.: 16/819,870

(22) Filed: Mar. 16, 2020

(30) Foreign Application Priority Data
Mar. 26, 2019 (JP) 2019-059266

(51) Int. Cl. F04D 29/58; F04D 25/06; H02K 9/22

(52) U.S. Cl. CPC F04D 29/5893; F04D 25/06; H02K 7/14; F05B 2270/325; H02K 9/22

(57) ABSTRACT

A control unit for an air pump provided with a motor is provided to perform a energization switching control for unfreezing of switching energization and non-energization to a coil of the motor to unfreeze the air pump when the air pump is determined to be frozen, and to vary at least any one of an energization time and a non-energization time to the coil when the energization switching control for unfreezing is to be carried out.

### CROSS-REFERENCE TO RELATED APPLICATIONS

This application is based upon and claims the benefit of priority from the prior Japanese Patent Application No. 2019-059266 filed on Mar. 26, 2019, the entire contents of which are incorporated herein by reference.

### BACKGROUND

### Technical Field

This disclosure relates to a fluid pump control unit, particularly to a fluid pump control unit provided in a secondary air supply apparatus, for example.

### Related Art

Japanese Patent Application Publication No. 2008-101561 (JP2008-101561A) has a description about a fluid pump control unit configured to cancel a motor locked-up state (a frozen state) by energizing a coil of a motor upon detection of the locked-up state.

### SUMMARY

### Technical Problem

In the pump control unit described in JP2008-101561A, energization and non-energization to the coil is switched at a constant period when the motor locked-up state has been detected and the coil of the motor is to be energized. In this example of fixing an energization time and a non-energization time, depending on a term length of the energization time and a term length of the non-energization time, a temperature of the coil may gradually increase due to remaining heat after energization to the coil, and thus there is a possibility that the temperature of the coil exceeds an allowable temperature. In order to prevent such excess of the coil temperature over the allowable temperature, only a small amount of current can be applied to the coil, that could cause delay in cancellation of the motor locked-up state (i.e., unfreeze of the fluid pump).

To address this situation, the present disclosure has been made to solve the above-mentioned problem and has a purpose of providing a fluid pump control unit that can achieve quick unfreezing of a fluid pump.

### Means of Solving the Problem

One aspect of the present disclosure made for solving the above problem provides a fluid pump control unit comprising a motor, wherein the control unit is configured to perform an energization switching control for unfreezing of switching energization and non-energization of the motor to the coil to unfreeze the fluid pump when the fluid pump has been determined to be frozen, and the control unit is configured to vary at least any one of an energization time and a non-energization time to the coil when performing the energization switching control for unfreezing.

According to this aspect, when the fluid pump is to be unfrozen upon determination of freeze of the fluid pump, a cycle of switching energization and non-energization to the coil of the motor is not made periodic but varied. Thus, the coil temperature can be increased to a target temperature below an allowable coil temperature in a short time and the thus increased temperature can be maintained by appropriately supplying (applying) the power (current or voltage) to the coil and energizing the coil in consideration with the allowable temperature of the coil. Therefore, heat transferred from the coil raises the temperature of a frozen portion (for example, frozen portions of a fin and surroundings of the fin) of the fluid pump in a short time, thus unfreezing the frozen portion in a short time. This achieves quick unfreezing of the fluid pump.

According to the fluid pump control unit of the present disclosure, quick unfreezing of a fluid pump can be achieved.

### BRIEF DESCRIPTION OF THE DRAWINGS

FIG. 1 is a schematic view of a secondary air supply apparatus including an air pump in the present embodiments;

FIG. 2 is a schematic view of an air pump partially including a sectional view and an external view;

FIG. 3 is a control flowchart showing a control content executed in a first embodiment;

FIG. 4 is a control flowchart showing a control (a switching energization control) content executed in the first embodiment;

FIG. 5 is a control flowchart showing a control (a post-unfreezing waiting control and a condensed water scavenging control) content executed in the first embodiment;

FIG. 6 is a diagram showing a relationship between predetermined time and the number of times for switching energization and non-energization;

FIG. 7 is a diagram showing a relationship between the predetermined time and a startup outside air temperature;

FIG. 8 is a diagram showing one example of a time chart of the control executed in the first embodiment;

FIG. 9 is a flowchart showing a control (a continuous energization control) content executed in a second embodiment;

FIG. 10 is a diagram showing a relationship between a current (a voltage) applied to a coil and elapsed time after execution of coil energization;

FIG. 11 is a diagram showing one example of a time chart of the control executed in the second embodiment;

FIG. 12 is a control flowchart showing a control content executed in a third embodiment;

FIG. 13 is a control flowchart showing a control (an energization-switching control) content executed in the third embodiment;

FIG. 14 is a diagram showing one example of a time chart of the control executed in the third embodiment;

FIG. 15 is a control flowchart showing a control (a continuous energization control) content executed in a fourth embodiment;

FIG. 16 is a diagram showing a relationship between predetermined time and the number of times for switching energization and non-energization;

FIG. 17 is a diagram showing one example of a time chart of the control executed in the fourth embodiment;

FIG. 18 is a control flowchart showing a control content executed in a fifth embodiment; and

FIG. 19 is a diagram showing one example of a time chart of the control executed in the fifth embodiment.

### DETAILED DESCRIPTION OF THE EXEMPLARY EMBODIMENTS

An air pump control unit as one embodiment of a fluid pump control unit of the present disclosure will be explained in detail below.

### <Secondary Air Supply Apparatus>

A secondary air supply apparatus including an air pump of the present embodiment is firstly explained before describing an air pump control unit of the present embodiment.

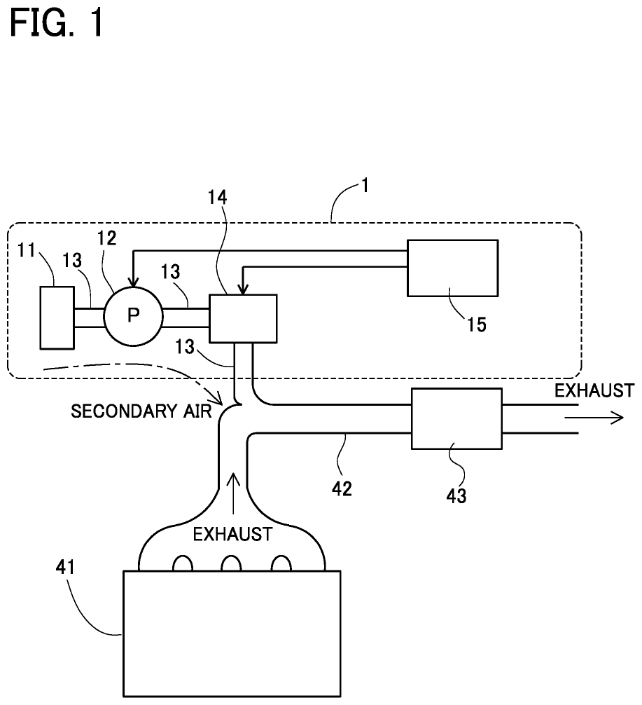

As shown in FIG. 1, a secondary air supply apparatus 1 includes a filter 11, an air pump 12, a secondary air passage 13, a flow control valve 14, a control unit 15, and others.

The filter 11 filters secondary air which is sucked by the air pump 12. The air pump 12 is provided in a portion between the filter 11 and the flow control valve 14 in the secondary air passage 13. Specifically, the air pump 12 is positioned on an upstream side of the flow control valve 14 in a flow direction of the secondary air in the secondary air passage 13. This air pump 12 is operated and halted by an instruction from the control unit 15. The air pump 12 corresponds to one example of “a fluid pump” of the present disclosure.

The flow control valve 14 is provided in a portion between the air pump 12 and an exhaust passage 42 that is connected to an engine 41 in the secondary air passage 13. Specifically, the flow control valve 14 is positioned on a downstream side of the air pump 12 in the flow direction of the secondary air in the secondary air passage 13. This flow control valve 14 opens and closes the secondary air passage 13 by the instruction from the control unit 15.

The control unit 15 includes a CPU (Central Processing Unit) and a storage device. The CPU carries out processing of a frozen pump unfreeze control, which will be described later, according to a program stored in the storage device, for example. This control unit 15 outputs operation signals to the air pump 12 and the flow control valve 14.

The air pump control unit of the present embodiment is constituted mainly by the air pump 12 and the control unit 15.

The secondary air supply apparatus 1 as configured above brings the flow control valve 14 into a valve-opening state and operates the air pump 12 so that the air (namely, the secondary air) is supplied to a catalyst 43 from the filter 11 through the secondary air passage 13 and the exhaust passage 42.

### <Air Pump>

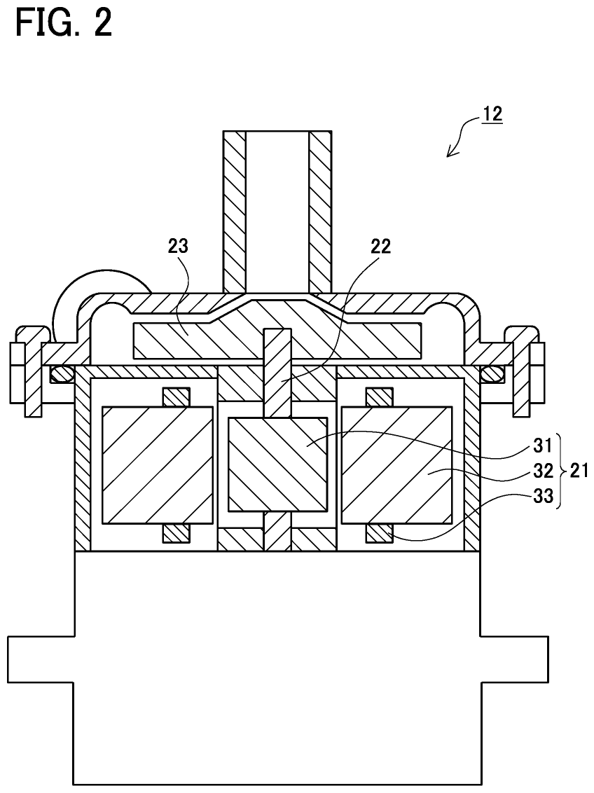

Next, the air pump 12 is explained. As shown in FIG. 2, the air pump 12 includes a motor 21, a rotary shaft 22, a fin 23, and others. The motor 21 is provided with a rotor 31, a core 32, a coil 33, and others. The coil 33 is provided in the core 32. Further, the rotary shaft 22 is connected to the rotor 31 of the motor 21 and the fin 23.

The air pump 12 having the above-mentioned configuration is made to rotate (drive) the rotary shaft 22 by applying current (voltage) to the coil 33 of the motor 21 to rotate (operate) the rotor 31. By this rotation of the rotary shaft 22, the fin 23 is rotated. Thus, the air pump 12 sucks the air from a suction port and discharges the thus sucked air through a discharge port.

### <Unfreeze Operation of Air Pump>

An unfreeze control (a frozen-pump unfreeze control) of the air pump 12 is now explained.

In FIG. 1, one case is assumed that exhaust gas flows backward through the secondary air passage 13 from the exhaust passage 42 and flows into the air pump 12 via the flow control valve 14, and thereby exhaust gas resides in the surroundings of the fin 23 of the air pump 12 shown in FIG. 2 (i.e., in a space between the fin 23 and a housing (main body) of the air pump 12). In this case, for example, after the engine 41 is stopped, a condensed water generated by exhaust gas may occur in or around the fin 23. Then, when the temperature outside the air pump 12 (i.e., the outside air temperature) becomes low, the condensed water may be frozen to further freeze the fin 23, thus disabling rotation of the fin 23. This could make the air pump 12 inoperative.

In response to this, as described in JP2008-101561A and Japanese Patent Application Publication No. 2009-209893, for example, it is considered that the energization to the coil 33 of the motor 21 is repeatedly executed and halted to raise the temperature of the coil 33 to transfer heat from the coil 33 to the fin 23 so that the fin 23 is unfrozen.

However, in JP2008-101561A and JP2009-209893A, the coil 33 is energized without taking into consideration with heat capacity of the coil 33, and thus the temperature of the coil 33 may exceed its allowable temperature and endurability of the motor 21 may be degraded. However, if the current (voltage) applied to the coil 33 is reduced in order to prevent excess of the coil temperature over the allowable temperature, increase in the coil temperature requires much time, and thus unfreezing of the air pump 12 could be delayed.

To address the above, the present embodiment achieves quick unfreezing of the air pump 12 by promptly increasing the temperature of the coil 33 to the target temperature and maintaining the increased temperature with considering the heat capacity of the coil 33.

### First Embodiment

A first embodiment of treating the frozen air pump 12 will be firstly described.

### (Explanation for Flowchart)

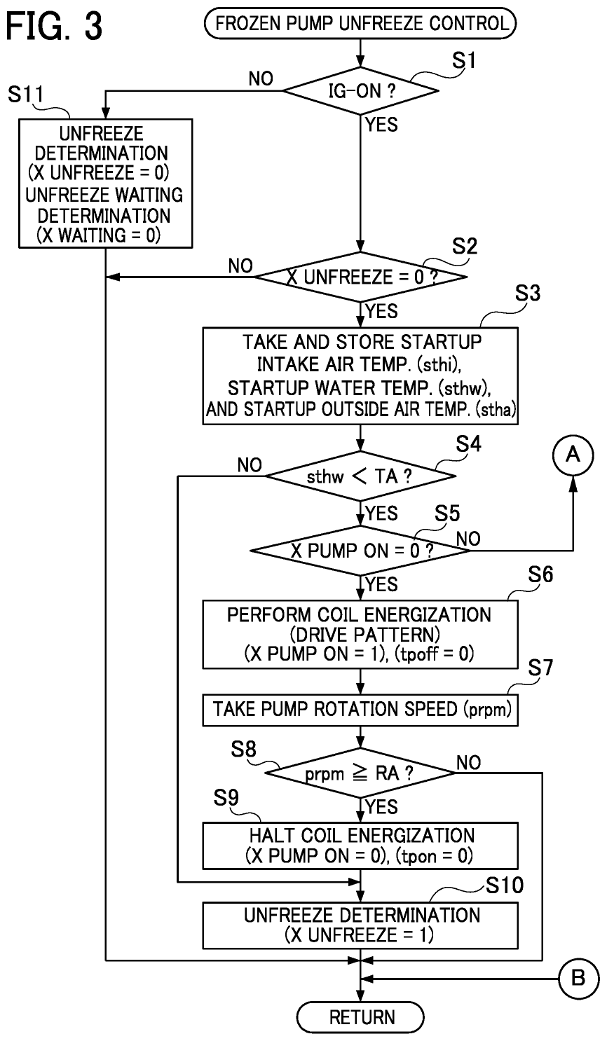

In the present embodiment, the control unit 15 executes control based on control flowcharts shown in FIGS. 3 to 5. First, as shown in FIG. 3, when an ignition switch is “ON” (denoted as “IG-ON” in the drawing) (step S1:YES) and an unfreeze flag (X unfreeze) is “0” (step S2:YES), the control unit 15 takes and stores a startup intake air temperature (sthi), a startup water temperature (sthw), and a startup outside air temperature (stha) (step S3).

The case where the unfreeze flag (X unfreeze) is “0” means a case where unfreeze determination of the air pump 12 has not been made. The unfreeze determination of the air pump 12 means a determination that the air pump 12 (more specifically, the fin 23) has been unfrozen. The startup intake air temperature (sthi), the startup water temperature (sthw), and the startup outside air temperature (stha) are the intake air temperature, the water temperature, and the outside air temperature at the time of starting up the engine 41, respectively.

Next, when the startup water temperature (sthw) is less than a predetermined temperature TA (step S4:YES), the control unit 15 determines that the outside air temperature is low and the air pump 12 (more specifically, the fin 23) may be frozen, and determines whether a pump operation flag (X pump ON) is “0” (step S5).

The pump operation flag (X pump ON) is set to “1” when the air pump 12 is operated, and when the air pump 12 is halted, the flag is set to “0”. The predetermined temperature TA is, for example, 5° C.

When the pump operation flag (X pump ON) is “0” (step S5:YES), that is, when the air pump 12 is halted, the control unit 15 executes energization to the coil 33 of the motor 21 in the air pump 12 (step S6). It should be noted that the energization to the coil 33 means, for example, when the motor 21 is provided with three-phase coil 33 including a U-phase, a V-phase, and a W-phase, executing the energization to at least one phase of the coil 33 among the three phases.

At this time, an energization pattern to the coil 33 is a drive pattern which is an energization pattern for driving (rotating) the rotor 31 of the motor 21. Namely, the drive pattern mentioned herein is a pattern of successively energizing the coil 33 of the U-phase, the V-phase, and the W-phase by way of driving (rotating) the rotor 31 when the motor 21 includes the three-phase coil 33 of the U-phase, the V-phase, and the W-phase, for example.

In this step S6, the control unit 15 sets the pump operation flag (X pump ON) to “1” and sets an elapsed time after halt of the coil energization (tpoff) to “0”. The elapsed time after the halt of the coil energization (tpoff) is lapse of time since halting the energization to the coil 33 (i.e., non-energization) has been started.

Next, the control unit 15 takes a pump speed (prpm) (step S7) and determines whether the pump speed (prpm) is equal to or higher than a predetermined rotation speed RA (step S8). The pump speed (prpm) is a rotational speed of the air pump 12. Further, the predetermined rotation speed RA is, for example, 100 rpm.

When the pump speed (prpm) is equal to or higher than the predetermined rotation speed (RA) (step S8:YES), it is considered that the air pump 12 (specifically, the fin 23) is not frozen and is operating. Accordingly, the control unit 15 halts the energization to the coil 33 (step S9), stops the air pump 12, and then carries out the unfreeze determination of the air pump 12 (step S10).

In step S9, the control unit 15 sets the pump operation flag (X pump ON) to “0” and sets an elapsed time after energization of the coil (tpon) to “0”. The elapsed time after the execution of the coil energization (tpon) is lapse of time since the energization to the coil 33 has been started. In step S10, the control unit 15 sets the unfreeze flag (X unfreeze) to “1”.

On the other hand, when the pump speed (prpm) is less than the predetermined rotation speed RA in step S8 (step S8:NO), it is considered that the air pump 12 is frozen and out of normal operation, and therefore, the control unit 15 determines that the air pump 12 is frozen and returns to the process of step S1.

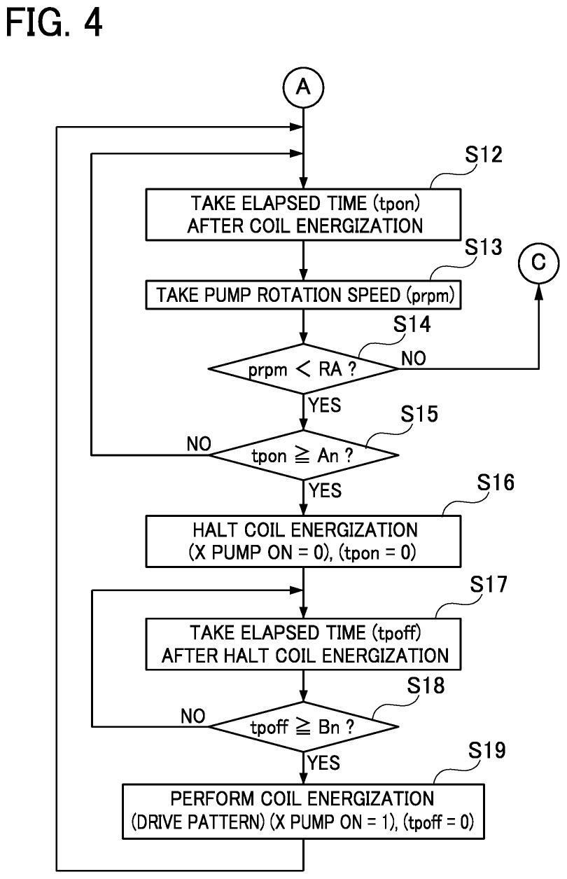

After returning to the process of step S1, the pump operation flag (X pump ON) is set to “1” in step S5 (step S5:NO), and accordingly, the control unit 15 executes the energization switching control for unfreezing shown in FIG. 4. The energization switching control for unfreezing is a control of performing unfreezing of the air pump 12 by switching between energization (i.e., executing energization) and non-energization (i.e., halt energization) to the coil 33.

In this manner, in the present embodiment, the control unit 15 performs the energization switching control for unfreezing upon freeze determination of the air pump 12.

In the energization switching control for unfreezing, as shown in FIG. 4, the control unit 15 takes the elapsed time (tpon) and the pump speed (prpm) after execution of the coil energization (steps S12 and S13), and determines whether the pump speed (prpm) is less than the predetermined rotation speed RA (step S14).

When the pump speed (prpm) is less than the predetermined rotation speed RA (step S14:YES), the control unit 15 determines that the air pump 12 is still frozen and halts the energization to the coil 33 in order to prevent an excessive rise (overmuch rise) in the temperature of the coil 33 (step S16) when the elapsed time after execution of the coil energization (tpon) becomes equal to or longer than a predetermined time An (step S15:YES). In step S16, the control unit 15 sets the pump ON flag (X pump ON) to “0” and sets the elapsed time after execution of the coil energization (tpon) to “0”.

Next, the control unit 15 takes the elapsed time after halt of the coil energization (tpoff) (step S17), and when the elapsed time after halt of the coil energization (tpoff) becomes equal to or longer than a predetermined time Bn (step S18:YES), the control unit 15 executes energization to the coil 33 (step S19) in order to prevent excessive drop in the temperature of the coil 33 (overmuch drop), and returns to the process of step S12. In S19, the control unit 15 sets the energization pattern to the coil 33 as the drive pattern. Further, in step S19, the control unit 15 sets the pump operation flag (X pump ON) to “1” and sets the elapsed time after halt of the coil energization (tpoff) to “0”.

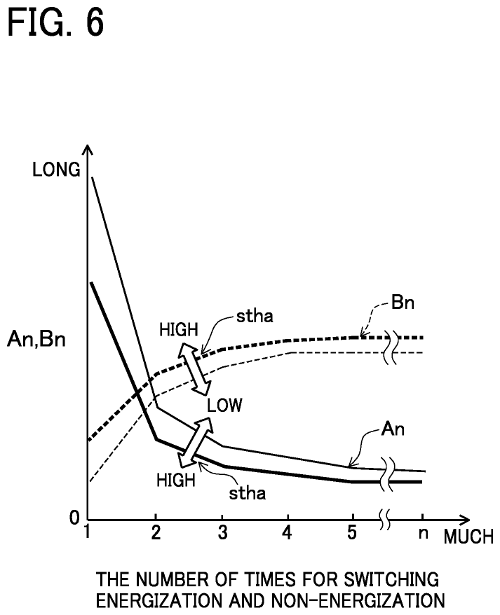

As indicated with solid lines in FIG. 6, the predetermined time An becomes shorter as the number of times for switching energization and non-energization increases. Further, as indicated with broken lines in FIG. 6, the predetermined time Bn becomes longer as the number of times n for switching on and off of the pump operation increases. The number of times for switching energization and non-energization is the number of times for switching the energization and the non-energization to the coil 33 since the energization switching control for unfreezing has been started. Further, “n” in An and Bn is a positive integer.

As indicated with the solid lines in FIG. 6, the predetermined time An becomes longer as the startup outside air temperature (stha) becomes lower and the time An becomes shorter as the startup outside air temperature (stha) becomes higher. Further, as indicated with the broken lines in FIG. 6, the predetermined time Bn becomes shorter as the startup outside air temperature (stha) becomes lower and the time Bn becomes longer as the startup outside air temperature (stha) becomes higher.

As mentioned above, in the present embodiment, when the control unit 15 executes the energization switching control for unfreezing shown in FIG. 4, the control unit 15 varies both the energization time to the coil 33 (i.e., the time of executing the energization, the predetermined time An) and the non-energization time (i.e., the time of halting the energization, the predetermined time Bn).

Specifically, the control unit 15 varies both the energization time and the non-energization time to the coil 33 according to the number of times for switching the energization and the non-energization. To be more specific, the control unit 15 shortens the energization time to the coil 33 as the number of times for switching the energization and the non-energization increases. In addition, the control unit 15 extends the non-energization time to the coil 33 as the number of times for switching the energization and the non-energization increases.

In addition, the control unit 15 varies both the energization time and the non-energization time to the coil 33 according to the startup outside air temperature (stha). Specifically, the control unit 15 extends the energization time to the coil 33 as the startup outside air temperature (stha) decreases. In addition, the control unit 15 shortens the non-energization time to the coil 33 as the startup outside air temperature (stha) decreases.

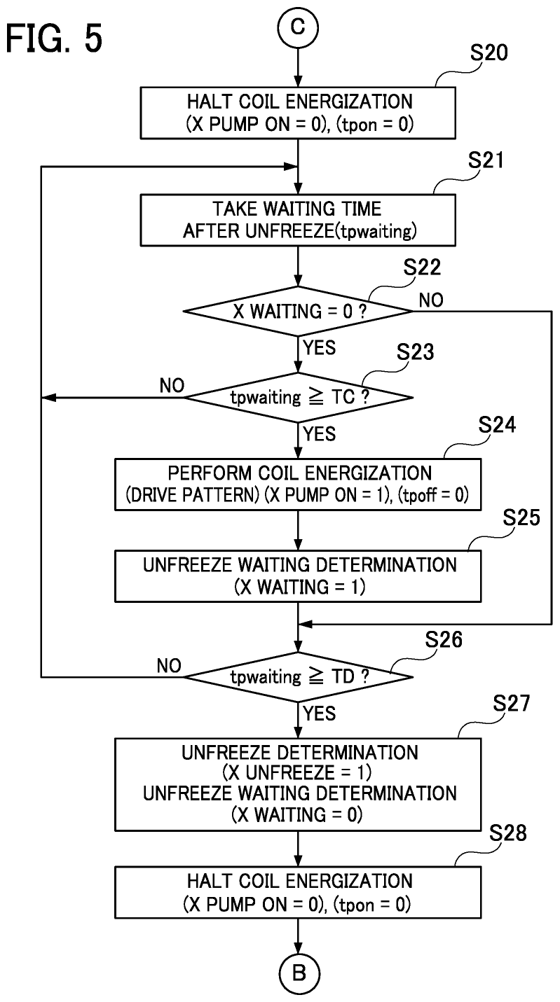

Returning to the explanation of FIG. 4, subsequently, when the pump speed (prpm) reaches or exceeds the predetermined rotation speed RA in step S14 (step S14:NO), it is considered that the air pump 12 normally operates. Accordingly, the control unit 15 determines that the air pump 12 has been unfrozen and performs a post-unfreezing waiting control and a condensed water scavenging control shown in FIG. 5.

As shown in FIG. 5, the control unit 15 halts the energization to the coil 33 (step S20), and thus stops operating the air pump 12. In step S20, the control unit 15 sets the pump operation flag (X pump ON) to “0” and sets the elapsed time after execution of the coil energization (tpon) to “0”.

Next, the control unit 15 takes the waiting time after unfreeze (tpwaiting) (step S21) and determines whether the unfreeze waiting flag (X waiting) is “0” (step S22). The waiting time after unfreeze (tpwaiting) is an elapsed time since the unfreezing determination of the air pump 12 (i.e., a time when the air pump 12 is determined to be unfrozen and the energization to the coil 33 is halted (step S20) to stop operation of the air pump 12).

When the unfreeze waiting flag (X waiting) is “0” (step S22:YES), the control unit 15 executes the energization to the coil 33 (step S24) when the waiting time after unfreezing (tpwaiting) becomes equal to or longer than a predetermined time TC (step S23:YES). In S24, the control unit 15 sets the energization pattern to the coil 33 as the drive pattern. Further in step S24, the control unit 15 sets the pump operation flag (X pump ON) to “1” and sets the elapsed time after halt of the coil energization (tpoff) to “0”.

In this manner, the energization to the coil 33 is halted and the air pump 12 is stopped to wait until frozen portions of the fin 23 and the surroundings of the fin 23 are completely unfrozen. Thereafter, the energization to the coil 33 is executed to operate the air pump 12 so that the condensed water generated at the time of unfreezing the air pump 12 is discharged to the secondary air passage 13 (see FIG. 1) downstream of the air pump 12.

Subsequently, the control unit 15 performs the unfreeze waiting determination (step S25), and when the waiting time after unfreezing (tpwaiting) becomes equal to or longer than the predetermined time TD (step S26:YES), the control unit 15 performs the unfreeze determination and the unfreeze waiting determination (step S27). In step S27, the control unit 15 sets the unfreeze flag (X unfreeze) to “1” and sets the unfreeze waiting flag (X waiting) to “0”.

Subsequently, the control unit 15 halts the energization to the coil 33 (step S28). In step S28, the control unit 15 sets the pump operation flag (X pump ON) to “0” and sets the elapsed time after execution of the coil energization (tpon) to “0”.

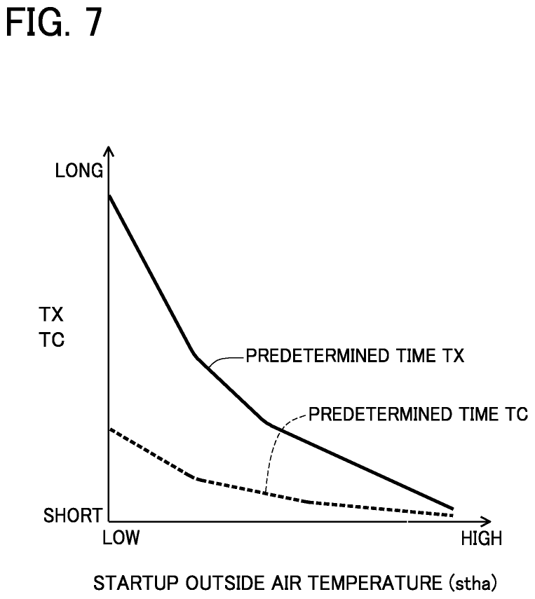

In this manner, after the energization switching control for unfreezing has been performed for a predetermined time TX, for example, the control unit 15 halts the air pump 12 for a predetermined time TC and operates the air pump 12. At this time, as shown in FIG. 7, the control unit 15 controls the predetermined time TX and the predetermined time TC on the basis of the startup outside air temperature (stha). To be specific, the predetermined time TX and the predetermined time TC are made longer as the startup outside air temperature (stha) decreases. The predetermined time TX is one example of a “first predetermined time” of the present disclosure, and the predetermined time TC is one example of a “second predetermined time” of the present disclosure.

As shown in FIG. 3, when the ignition switch is “OFF” (step S1:NO), the control unit 15 performs the unfreeze determination and the unfreeze waiting determination (step S11). In step S11, the control unit 15 sets the unfreeze flag (X unfreeze) and the unfreeze waiting flag (X waiting) to “0”.

When the startup water temperature (sthw) is equal to or higher than the predetermined temperature TA in step S4 (step S4:NO), the control unit 15 performs the unfreeze determination (step S10).

### (Explanation for Time Chart)

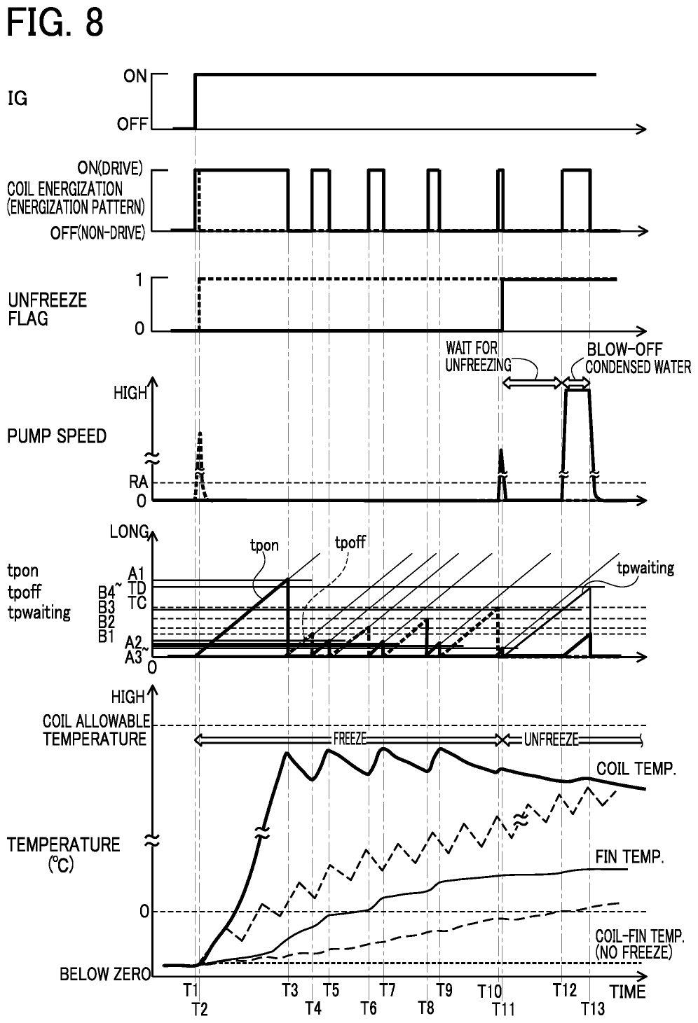

By executing the control based on the control flowchart described above, for example, the control represented by a control time chart shown in FIG. 8 is executed.

As shown in FIG. 8, at time T1, the ignition switch is turned “ON” and the energization to the coil 33 (denoted as “coil energization” in the drawing) is initialized (denoted as “ON” in the drawing). At this time, the energization pattern to the coil 33 is the drive pattern.

Herein, the air pump 12 is frozen and out of operation, and therefore the unfreeze flag (X unfreeze) remains “0” and the pump speed (rprm) remains “0” at time T2.

When the air pump 12 is not frozen and operated, as indicated with a broken line in FIG. 8, the unfreeze flag (X unfreeze) is set to “1” at time T2, and the pump speed (rprm) becomes equal to or higher than the predetermined rotation speed RA.

Next, at time T3 when the predetermined time A1 has elapsed from the time T1, the energization to the coil 33 is halted (denoted as “OFF” in the drawing). Thereby, the temperature of the coil 33 is greatly increased in a short time and then drops to maintain the high temperature below the allowable temperature of the coil 33.

Next, at time T4 when the predetermined time B1 has elapsed from the time T3, the energization to the coil 33 is executed again. Thereby, the temperature of the coil 33 increases.

Next, at time T5 when the predetermined time A2 has elapsed from the time T4, the energization to the coil 33 is halted again. Thereby, the temperature of the coil 33 drops.

Next, at time T6 when the predetermined time B2 has elapsed from the time T5, the energization to the coil 33 is executed again. Thereby, the temperature of the coil 33 increases.

Thereafter, from time T6 to time T10, the energization to the coil 33 is repeatedly executed and halted as similar to the above.

Subsequently, at time T11, the pump speed (prpm) reaches or exceeds the predetermined rotation speed RA, and thus it is determined that the air pump 12 has been unfrozen. Accordingly, the energization to the coil 33 is halted and the unfreeze flag (X unfreeze) is set to “1”.

As mentioned above, when the air pump 12 is to be unfrozen by switching the energization and the non-energization to the coil 33, the predetermined time An and the predetermined time Bn are varied as predetermined time A1, A2, A3, . . . and predetermined time B1, B2, B3 . . . in order to change the energization time and the non-energization time to the coil 33. Accordingly, the temperature of the coil 33 can be maintained below the allowable temperature (denoted as “coil allowable temperature” in the drawing).

Thereafter, from time T11 to time T12 when the predetermined time TC has elapsed from the time T11, the energization to the coil 33 has been halted as the unfreeze waiting state. Subsequently, the energization to the coil 33 is executed from time T12 to time T13 when the predetermined time TD has elapsed from the time T12 to drive the rotor 31 so that the air pump 12 is operated. Accordingly, the condensed water adhered to the fin 23 and the condensed water in the surroundings of the fin 23 are discharged from the air pump 12. Namely, the condensed water is blown off.

In a section of “Temperature (° C.)” in FIG. 8, the temperature of the coil 33 and the temperature of the fin 23 of the present embodiment are indicated by solid lines, and the temperature of a coil and the temperature of a fin of the conventional art are indicated with broken lines.

### (Modifications)

As a modification, the control unit 15 may vary only one of the energization time and the non-energization time to the coil 33 when performing the energization switching control for unfreezing. Specifically, the control unit 15 may vary only one of the energization time and the non-energization time to the coil 33 according to the number of times for switching the energization and the non-energization. Further, the control unit 15 may vary only one of the energization time and the non-energization time to the coil 33 according to the startup outside air temperature (stha). Furthermore, the control unit 15 may control only one of the predetermined time TX and the predetermined time TC on the basis of the startup outside air temperature (stha).

### <Operations and Effects of Present Embodiment>

As described above, according to the present embodiment, the control unit 15 performs the energization switching control for unfreezing when the air pump 12 is determined to be frozen. When performing the energization switching control for unfreezing, the control unit 15 varies at least one of the energization time and the non-energization time to the coil 33.

In this manner, in the present embodiment, when the air pump 12 is to be unfrozen at the time of freeze determination of the air pump 12, the cycle of switching between the energization and the non-energization to the coil 33 is not kept constant but varied. This allows short-time rise in the temperature of the coil 33 to the target temperature below the allowable temperature of the coil 33 and the thus increased temperature can be maintained while appropriately supplying (applying) electric power (current or voltage) to the coil 33 in consideration with the allowable temperature of the coil 33 to energize the coil 33. Therefore, the temperature of the frozen portions of the fin 23 and the surroundings of the fin 23 increases in a short time due to the heat transfer from the coil 33, thereby unfreezing the frozen portions in a short time. Consequently, the air pump 12 can be quickly unfrozen.

In addition, the control unit 15 varies at least one of the energization time and the non-energization time to the coil 33 according to the number of times for switching the energization and the non-energization.

This repetition of the energization to the coil 33 leads to suppression of gradual increase in the temperature of the coil 33 that has been increased due to the remaining heat after the energization to the coil 33. Therefore, it is possible to prevent the temperature of the coil 33 from exceeding its allowable temperature.

Further, the temperature of the coil 33 and the temperature of the neighborhood of the coil 33 are increased by the energization to the coil 33, and accordingly, the more the number of times for switching the energization and the non-energization increases, the less heat radiation from the coil 33 to the neighborhood is generated. This leads to acceleration of rise in the temperature of the coil 33 by the energization to the coil 33, and thus there may be increase in overshoot that causes excess of the temperature of the coil 33 over the allowable temperature unless the energization time to the coil 33 is shortened.

To address this, the control unit 15 shortens the energization time to the coil 33 as the number of times for switching the energization and the non-energization increases.

As a result, it is possible to suppress gradual increase in the temperature of the coil 33 due to the remaining heat after the energization to the coil 33 as the number of times for switching the energization and the non-energization increases. Accordingly, the temperature of the coil 33 can be further reliably prevented from exceeding the allowable temperature.

Further, the temperature of the coil 33 and the temperature of the neighborhood of the coil 33 are increased by the energization to the coil 33, so that the more the number of times for switching the energization and the non-energization increases, the more slowly the temperature of the coil 33 and the temperature of the neighborhood of the coil 33 decrease during halt of the energization to the coil 33.

Accordingly, the control unit 15 extends the non-energization time to the coil 33 as the number of times for switching the energization and the non-energization increases.

Consequently, even if the temperature of the coil 33 once rises due to the remaining heat after the energization to the coil 33, the temperature of the coil 33 drops in the non-energization time to the coil 33, and therefore, the temperature of the coil 33 can be suppressed from gradual rise even when the number of times for switching the energization and the non-energization increases. Therefore, it is possible to more reliably prevent the temperature of the coil 33 from exceeding the allowable temperature.

Further, the control unit 15 varies at least one of the energization time and the non-energization time to the coil 33 according to the startup outside air temperature (stha).

This makes it possible to stably suppress gradual rise in the temperature of the coil 33 that has been increased due to the remaining heat after the energization to the coil 33 by way of repeating the energization to the coil 33 of the motor 21 regardless of the startup outside air temperature (stha). Therefore, the temperature of the coil 33 can be prevented from exceeding its allowable temperature regardless of the startup outside air temperature (stha).

Further, the control unit 15 extends the energization time to the coil 33 as the startup outside air temperature (stha) decreases.

This makes it possible to increase the temperature of the coil 33 to the target temperature in a short time by extending the energization time to the coil 33 of the motor 21 even when the startup outside air temperature (stha) is low. Accordingly, even if the startup outside air temperature (stha) is low, the air pump 12 can be unfrozen quickly.

Further, the control unit 15 shortens the non-energization time to the coil 33 as the startup outside air temperature (stha) decreases.

This makes it possible to increase the temperature of the coil 33 to the target temperature in a short time by shortening the non-energization time of the coil 33 of the motor 21 even when the startup outside air temperature (stha) is low. Accordingly, even if the startup outside air temperature (stha) is low, the air pump 12 can be unfrozen quickly.

Further, after executing the energization switching control for unfreezing for the predetermined time TX, the control unit 15 halts the air pump 12 for the predetermined time TC, and then operates the air pump 12.

In this manner, the air pump 12 is not operated immediately after being unfrozen by the energization switching control for unfreezing. The air pump 12 is instead operated after having been halted for the predetermined time TC. Thereby, even in a case where ice flakes (i.e., frozen pieces generated by unfreezing the frozen portion) exist in the frozen portions of the fin 23 and the surroundings of the fin 23 when the air pump 12 is unfrozen by the energization switching control for unfreezing, the air pump 12 can be operated after complete unfreezing of the ice flakes. Operation of the air pump 12 allows the condensed water that has been generated after unfreezing to be discharged and scavenged. Accordingly, during operation of the air pump 12, it is possible to restrain degradation in the endurability of the air pump 12 due to damage to the fin 23 damaged by collision of the ice flakes existing in the fin 23 and the surroundings of the fin 23 (i.e., the operating portion). Therefore, the air pump 12 can be operated with maintaining the endurability of the air pump 12 to discharge and scavenge the condensed water generated after unfreezing.

Further, the control unit 15 controls at least one of the predetermined time TX and the predetermined time TC on the basis of the startup outside air temperature (stha).

Accordingly, the air pump 12 can be operated after the ice flakes existing in the fin 23 and the surroundings of the fin 23 are completely unfrozen regardless of the startup outside air temperature (stha). Therefore, regardless of the startup outside air temperature (stha), it is possible to restrain degradation in the endurability of the air pump 12 due to damage to the fin 23 damaged by collision of the ice flakes existing in the fin 23 and the surroundings of the fin 23 on the fin 23 during operation of the air pump 12.

At this time, specifically, the control unit 15 extends the predetermined time TX as the startup outside air temperature (stha) decreases. In addition, the control unit 15 extends the predetermined time period TC as the startup outside air temperature (stha) decreases.

Accordingly, even if the startup outside air temperature (stha) is low, the air pump 12 can be operated after the ice flakes existing in the fin 23 and the surroundings of the fin 23 are completely unfrozen. Therefore, even when the startup outside air temperature (stha) is low, it is possible to restrain degradation in the endurability of the air pump 12 due to the damage to the fin 23 damaged by collision of the ice flakes existing in the fin 23 and the surroundings of the fin 23 during operation of the air pump 12.

### Second Embodiment

A second embodiment embodying a treatment of a frozen air pump 12 is now explained with focus on different points from the first embodiment.

### (Explanation for Flow Chart)

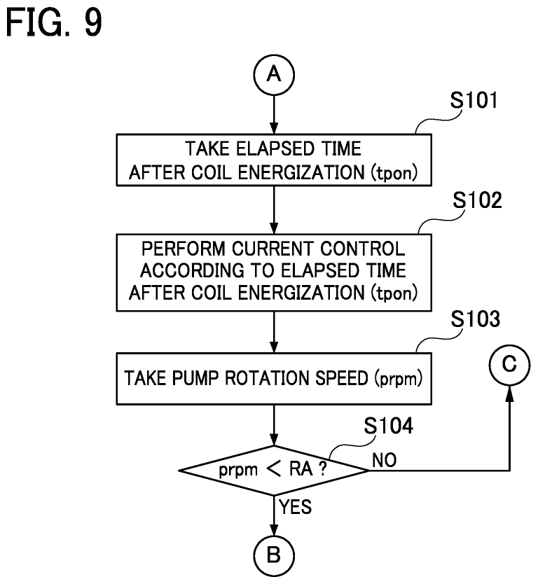

As different points from the first embodiment, a control unit 15 of the embodiment executes a continuous energization control for unfreezing shown in FIG. 9 instead of the above-mentioned energization switching control for unfreezing shown in FIG. 4. As shown in FIG. 9, the control unit 15 takes an elapsed time after execution of coil energization (tpon) (step S101), and then carries out a current control (or a voltage control) according to the elapsed time after execution of the coil energization (tpon) (step S102). In other words, in step S102, the control unit 15 controls the current (or the voltage) applied to a coil 33 according to the elapsed time after execution of the coil energization (tpon).

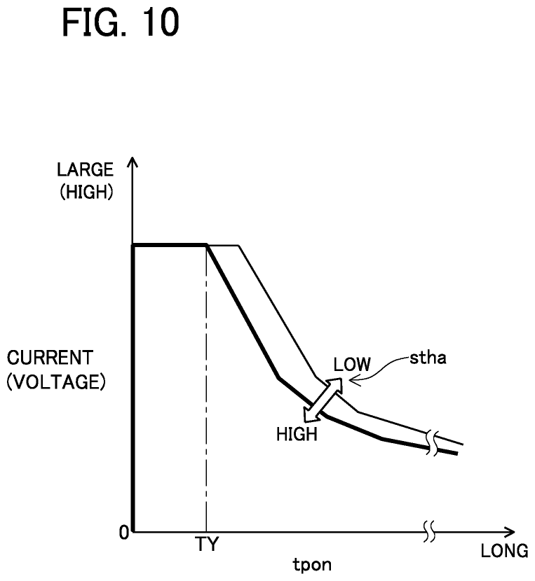

Specifically, as shown in FIG. 10, when the elapsed time after execution of the coil energization (tpon) reaches or becomes longer than a predetermined time TY, the control unit 15 reduces the current (or the voltage) applied to the coil 33 as the elapsed time after execution of the coil energization (tpon) becomes longer.

As mentioned above, in the present embodiment, the control unit 15 performs the continuous energization control for unfreezing of unfreezing the air pump 12 with continuously energizing the coil 33. Thus, the control unit 15 gradually reduces the electric power supplied to the coil with lapse of time when performing this continuous energization control for unfreezing.

Herein, a gradual decrease rate of power that is a ratio of gradually reducing the supply power (i.e., the current (or the voltage) applied to the coil 33) to the coil 33 with respect to the lapse of time is controlled according to the startup outside air temperature (stha). At this time, the gradual decrease rate of power is made smaller as the startup outside air temperature (stha) becomes lower.

Returning to the explanation of FIG. 9, the control unit 15 subsequently takes the pump speed (prpm) (step S103) and performs the post-unfreezing waiting control and the condensed water scavenging control shown in FIG. 5 when the pump speed (prpm) is equal to or more than a predetermined rotation speed RA (step S104:NO).

### (Explanation for Time Chart)

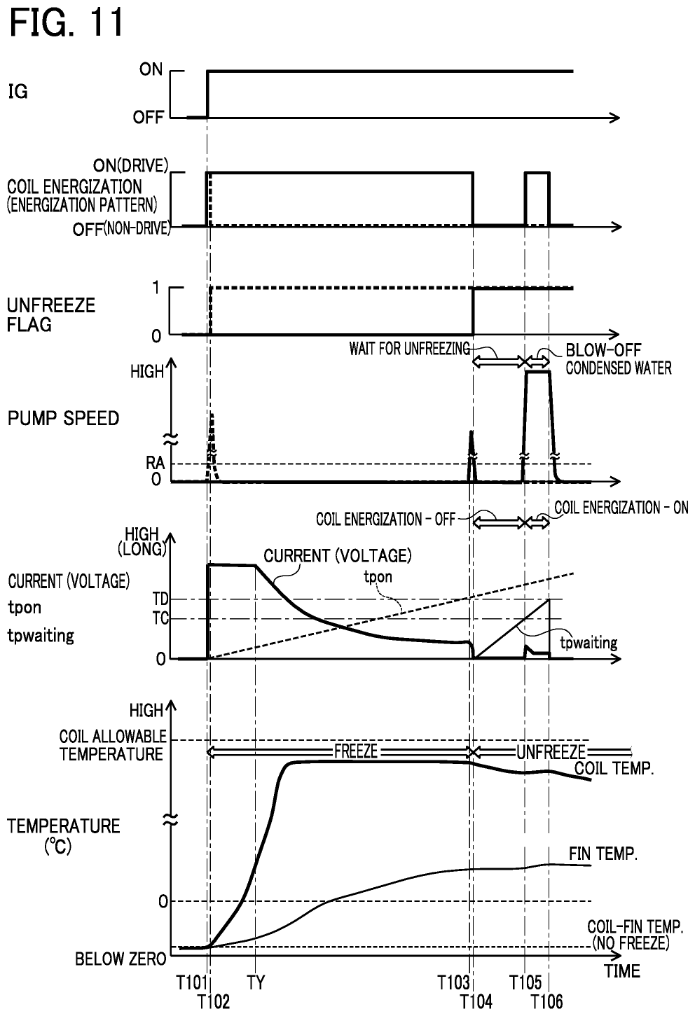

By executing the control based on the above-mentioned control flowchart, for example, a control illustrated by a control time chart in FIG. 11 is carried out.

As shown in FIG. 11, in time T101, an ignition switch turns “ON” so that execution of the energization to the coil 33 is started. At this time, the energization pattern to the coil 33 is a drive pattern.

Thereafter, the energization to the coil 33 continues to time T104, but the current (or the volume) applied to the coil 33 gradually decreases at the predetermined time TY and thereafter. Thus, the temperature of the coil 33 is maintained less than the coil allowable temperature.

Subsequently, when the air pump 12 is unfrozen and the pump speed reaches or becomes more than the predetermined rotation speed RA, the X unfreeze flag turns “1” in time T104, thus halting the energization to the coil 33.

### <Effects and Operations of Present Embodiment>

According to the above-mentioned present embodiment, the control unit 15 continuously performs the continuous energization control for unfreezing when the air pump 12 is determined to be frozen. Further, the control unit 15 gradually reduces the supply power (i.e., the current or the voltage applied to the coil 33) to the coil 33 with the lapse of time during this continuous energization control for unfreezing.

As mentioned above, in the present embodiment, when the air pump 12 is to be unfrozen during frozen determination of the air pump 12, the supply power to the coil 33 is not constant but gradually reduced with the lapse of time. This makes it possible to increase the temperature of the coil 33 to the target temperature below the allowable temperature of the coil 33 in a short time and to maintain the thus increased temperature by way of appropriately supplying the power to the coil 33 in consideration with the allowable temperature of the coil 33. Accordingly, the temperature of the frozen portions of the fin 23 and the surroundings of the fin 23 is increased in a short time by the heat transfer from the coil 33, thereby unfreezing the frozen portions in a short time. Therefore, the air pump 12 can be quickly unfrozen.

Further, the control unit 15 controls the gradual decrease rate of the power that is a ratio of gradually reducing the supply power to the coil 33 with the lapse of time based on the startup outside air temperature (stha).

Accordingly, the temperature of the coil 33 can be increased to the target temperature in a short time by energizing the coil 33 irrespective of the startup outside air temperature (stha). The air pump 12 can be thereby quickly unfrozen regardless of the startup outside air temperature (stha).

At this time, specifically, the control unit 15 reduces the gradual decrease rate of the power as the startup outside air temperature (stha) becomes lower.

Accordingly, even when the startup outside air temperature (stha) is low, the gradual decrease rate of the power becomes small, and thus the temperature of the coil 33 can be increased to the target temperature in a short time by energizing the coil 33. Therefore, the air pump 12 can be quickly unfrozen irrespective of the startup outside air temperature (stha) in a more reliable manner.

Also in the present embodiment, as similar to the first embodiment, the control unit 15 performs the continuous energization control for unfreezing for the predetermined time TX, halts operation of the air pump 12 for the predetermined time TC, and then operates the air pump 12.

### Third Embodiment

A third embodiment embodying a treatment of a frozen air pump 12 is now explained with focus on different points from the first and second embodiments.

### (Explanation for Flowchart)

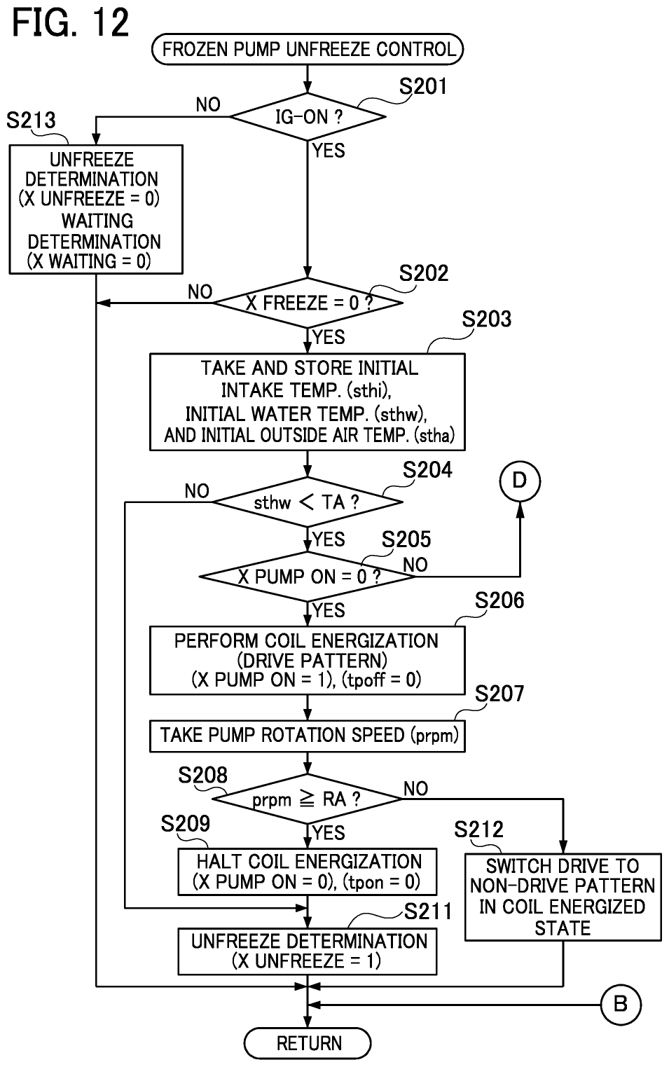

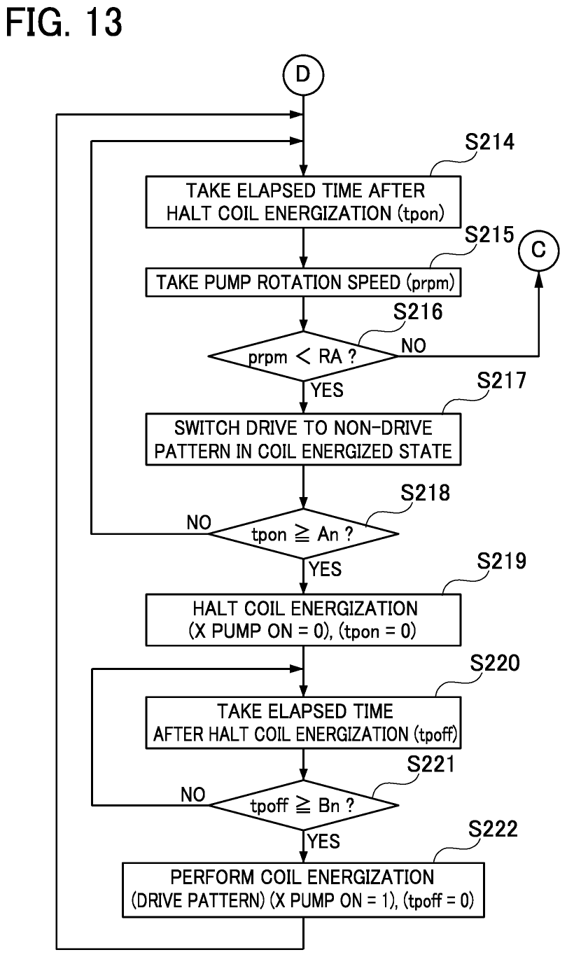

In the present embodiment, a control unit 15 executes a control based on control flowcharts shown in FIGS. 12 and 13 and the above-mentioned FIG. 5. As shown in FIG. 12, the control unit 15 carries out energization to a coil 33 (step S206) when a pump operation flag (X pump ON) is “0” in step S205 (step S205:YES). At this time, the energization pattern to the coil 33 is a drive pattern.

Subsequently, the control unit 15 takes a pump speed (prpm) (step S207) and when the pump speed (prpm) is less than the predetermined rotation speed (RA) (step S208:NO), the control unit 15 switches the energization pattern to the coil 33 from the drive pattern to a non-drive pattern (step S212) in a state where the coil 33 has been energized.

Herein, the non-drive pattern is an energization pattern not to drive (rotate) a rotor 31 of a motor 21, namely, an energization pattern of keeping a halted state of the rotor 31 of the motor 21. The non-drive pattern mentioned herein is a pattern of sequentially energizing each phase of a U-phase, a V-phase, and a W-phase of the coil 33 while sustaining driving (rotation) of the rotor 31 in a case where the motor 21 includes the coil 33 having the three phases of the U-phase, the V-phase, and the W-phase, for example.

Further, in the present embodiment, in an energization switching control for unfreezing shown in FIG. 13, the control unit 15 switches the energization pattern from the drive pattern to the non-drive pattern while the coil 33 has been energized (step S217) when the pump speed (prpm) is less than the predetermined rotation speed RA in step S216 (step S216:YES).

As mentioned above, when executing the energization switching control for unfreezing, the control unit 15 sets the energization pattern of energizing the coil 33 to the non-drive pattern in a state where the coil 33 has been energized so that the rotor 31 of the motor 21 is not rotated.

Furthermore, the control unit 15 executes energization to the coil 33 (step S222) when an elapsed time after halt of the coil energization (tpoff) reaches or becomes more than a predetermined time Bn (step S221:YES). At this time, the energization pattern to the coil 33 is the drive pattern.

### (Explanation for Time Chart)

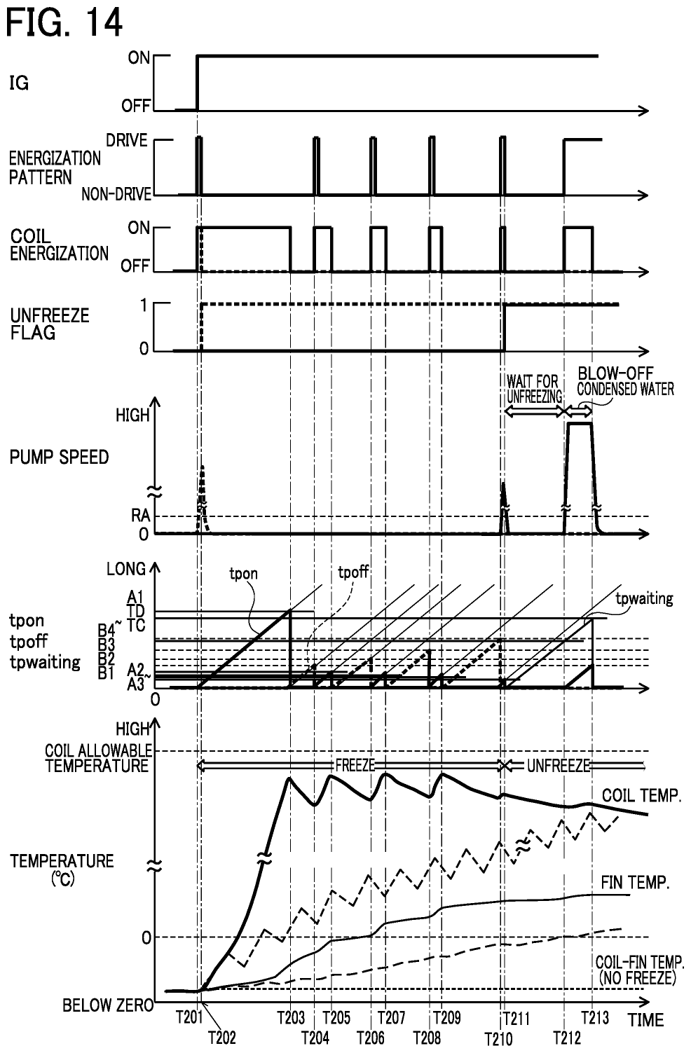

By executing a control based on the above-mentioned control flowchart, for example, a control represented with a control time chart shown in FIG. 14 is carried out.

As shown in FIG. 14, in time T201, an ignition switch turns “ON”, and energization to the coil 33 is started. At this time, the energization pattern to the coil 33 is the drive pattern.

Directly after that, in time T202, the energization pattern to the coil 33 turns to the non-drive pattern. Subsequently, the energization to the coil 33 continues until time T203, but the energization pattern to the coil 33 remains as the non-drive pattern. In other words, from time T202 to time T203, the energization to the coil 33 is executed with no rotation (driving) of the rotor 31. Similarly, in each of time T204 to T205, time T206 to T207, and time T208 to T209, the energization pattern to the coil 33 once turns to the drive pattern, but soon turns to the non-drive pattern.

As mentioned above, in the present embodiment, when the energization to the coil 33 is to be started, the control unit 15 once turns the energization pattern to the coil 33 to the drive pattern in order to confirm whether the air pump 12 is frozen, and directly after that, when the air pump 12 is determined to be frozen, the control unit 15 turns the energization pattern to the non-drive pattern.

### <Effects and Operations of Present Embodiment>

According to the above-mentioned present embodiment, when performing the energization switching control for unfreezing, the control unit 15 suspends rotation of the rotor 31 of the motor 21 except a case where the energization to the coil 33 has already been started.

As mentioned above, in the present embodiment, the energization switching control for unfreezing is executed in a state where the rotor 31 is halted, and accordingly, the air pump 12 can be unfrozen with restraining a load subjected to connecting portions of a rotary shaft 22 connected to the rotor 31 and the fin 23 connected to the rotary shaft 22 in the air pump 12. Therefore, the air pump 12 can be unfrozen with maintaining the endurability of the air pump 12.

### Fourth Embodiment

A fourth embodiment embodying a treatment of a frozen air pump 12 is now explained with focus on different points from the first to third embodiments.

### (Explanation for Flowchart)

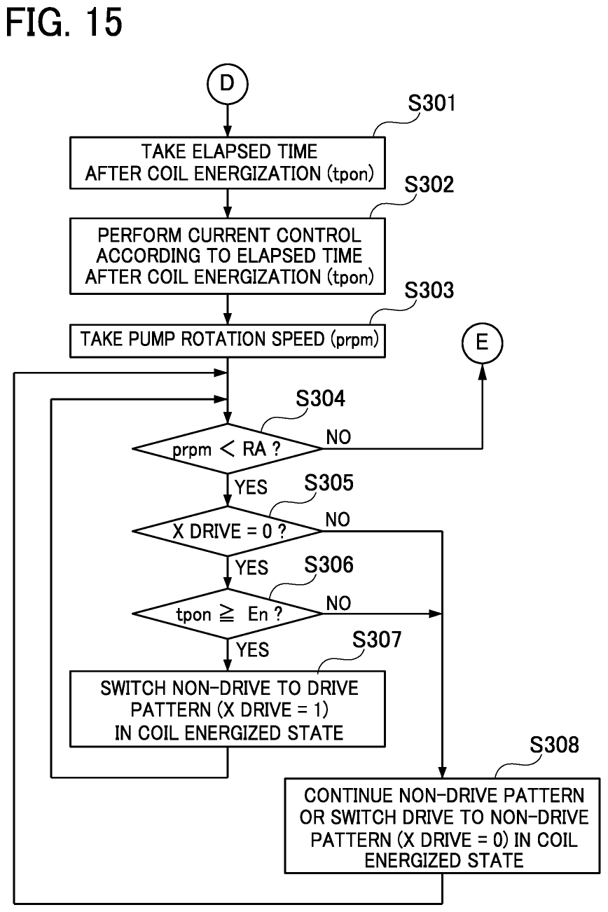

In the present embodiment, as a different point from the third embodiment, a control unit 15 performs a continuous energization control for unfreezing shown in FIG. 15 instead of the above-mentioned switching energization unfreeze control shown in FIG. 13. As shown in FIG. 15, the control unit 15 determines whether a drive flag (X drive) is “0” (step S305) when a pump speed (prpm) is less than a predetermined rotation speed RA in step S304 (step S304:YES).

When the drive flag (X drive) is “0” (step S305:YES) and an elapsed time after execution of coil energization (tpon) reaches or becomes more than a predetermined time En (step S306:YES), the control unit 15 switches an energization pattern to the coil 33 from a non-drive pattern to a drive pattern in a state where the coil 33 has been energized (step S307) and then returns the process to S304. In step S307, the control unit 15 sets the drive flag (X drive) to “1”.

Further, when the drive flag (X drive) is “1” (step S305:NO) and when the elapsed time after execution of the coil energization (tpon) is less than the predetermined time En (step S306:NO), the control unit 15 maintains the energization pattern as the non-drive pattern while the coil 33 has been energized or the control unit 15 switches the drive pattern to the non-drive pattern (step S308) and returns the process to step S304.

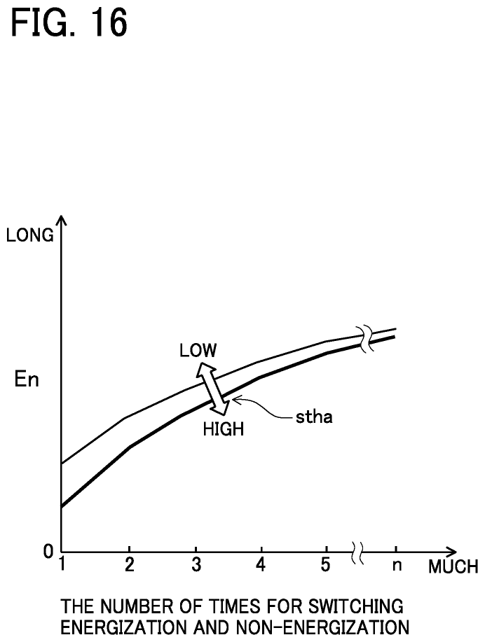

Herein, as shown in FIG. 16, the predetermined time En becomes longer as the number of times for switching the energization and the non-energization increases. Further, the predetermined time En becomes longer as the startup outside air temperature (stha) decreases and the predetermined time En becomes shorter as the startup outside air temperature (stha) increases.

### (Explanation for Time Chart)

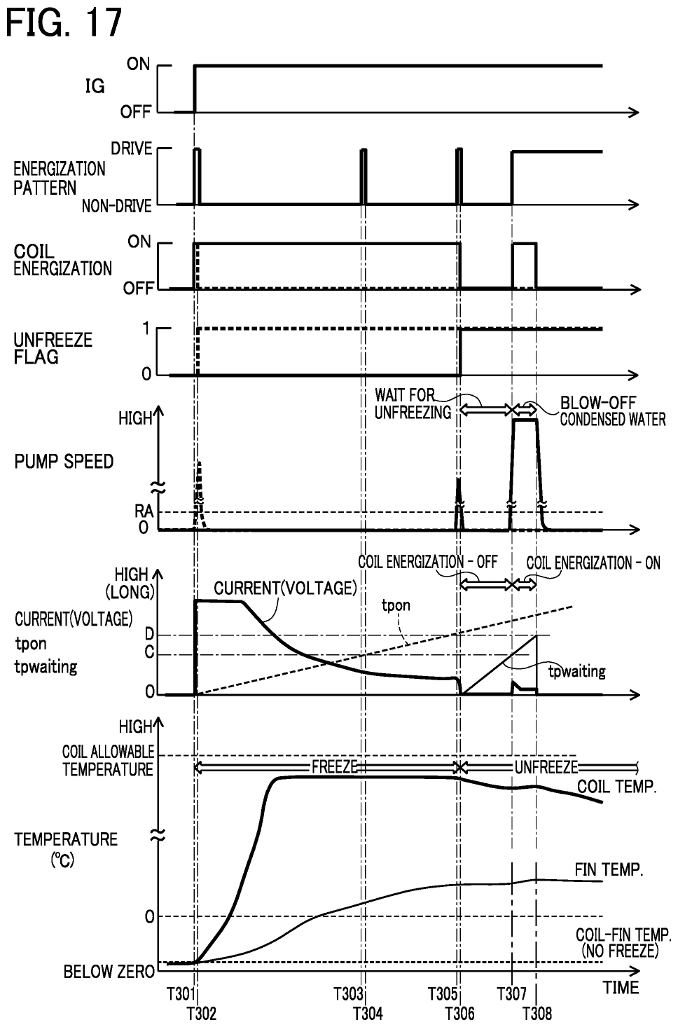

By executing a control based on the above-mentioned control flow chart, for example, a control represented as a control time chart shown in FIG. 17 is carried out.

As shown in FIG. 17, in time T301, an ignition switch turns “ON” and energization to the coil 33 is started. At this time, the energization pattern to the coil 33 is the drive pattern.

Directly after that, in time T302, the energization pattern to the coil 33 turns to the non-drive pattern. Subsequently, energization to the coil 33 continues to time T303 when the predetermined time En has elapsed from time T301, but the energization pattern to the coil 33 remains in the non-drive pattern. Then, in time T303, the energization pattern to the coil 33 turns to the drive pattern. Subsequently, similarly to the above, the energization pattern to the coil 33 turns to the drive pattern once from time T303 to T305, and turns to the non-drive pattern directly thereafter.

As mentioned above, in the present embodiment, at the time of starting energization to the coil 33 and at each predetermined time interval thereafter, the control unit 15 once sets the energization pattern to the coil 33 to the drive pattern and directly after that, sets to the non-drive pattern in order to confirm whether the air pump 12 is frozen.

### <Effects and Operations of Present Embodiment>

As mentioned above, according to the present embodiment, when performing the continuous energization control for unfreezing, the control unit 15 suspends rotation of the rotor 31 of the motor 21 except the time of starting energization to the coil 33 and each predetermined time interval thereafter.

Accordingly, in the present embodiment, the continuous energization control for unfreezing is performed with halting the rotor 31, and thus the air pump 12 can be unfrozen with restraining the load subjected to connecting portions of a rotary shaft 22 connected to the rotor 31 and a fin 23 connected to the rotary shaft 22 in the air pump 12. Therefore, the air pump 12 can be unfrozen with maintaining the endurability of the air pump 12.

### Fifth Embodiment

A fifth embodiment of a treatment of a frozen air pump 12 is now explained.

### (Explanation for Flowchart)

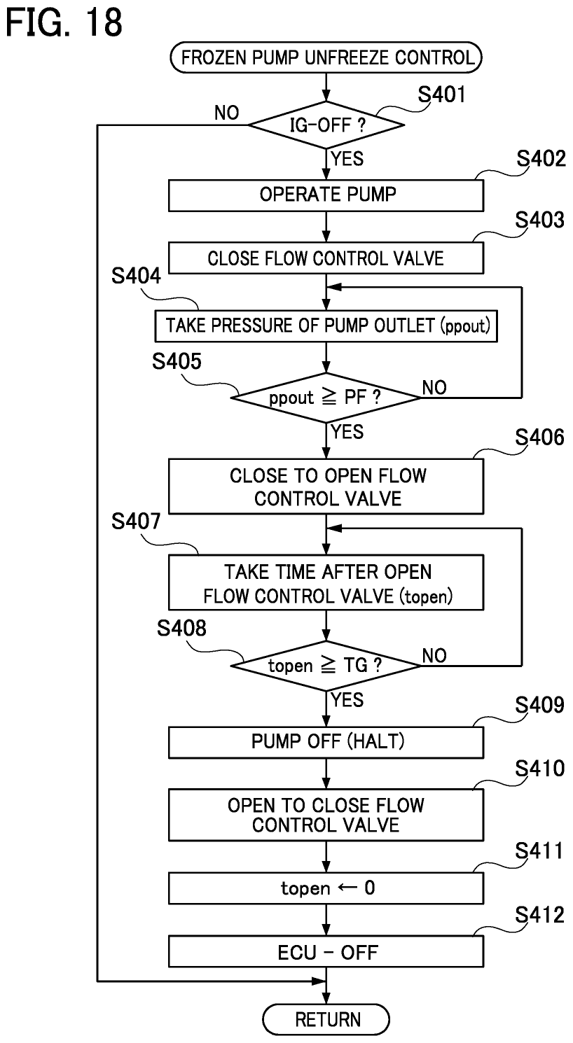

In the present embodiment, the control unit 15 executes a control based on a control flowchart shown in FIG. 18. As shown in FIG. 18, when an ignition switch is “OFF” (denoted as “IG-OFF” in the figure) (step S401:YES), the control unit 15 operates the air pump 12 (step S402) to bring a flow control valve 14 in a valve-closing state (step S403).

Subsequently, the control unit 15 takes a pump outlet pressure (ppout) (step S404), and when the pump outlet pressure (ppout) reaches or becomes more than a predetermined pressure PF (step S405:YES), the control unit 15 brings the flow control valve 14 into a valve-opening state from the valve-closing state (step S406). Herein, the pump outlet pressure (ppout) is a pressure on a downstream side of the air pump 12, namely on a side of the flow control valve 14.

Subsequently, the control unit 15 takes a time after valve-opening of the flow control valve (topen) that is an elapsed time after the flow control valve has been opened (step S407), and when the time after valve-opening of the flow control valve (topen) reaches or becomes more than a predetermined time TG (step S408:YES), the control unit 15 halts the air pump 12 (step S409).

Subsequently, the control unit 15 brings the flow control valve 14 from the valve-opening state to the valve-closing state (step S410), sets the time after valve-opening of the flow control valve (topen) to “0” (step S411), and sets an ECU (not shown) to “OFF” (step S412).

### (Explanation for Time Chart)

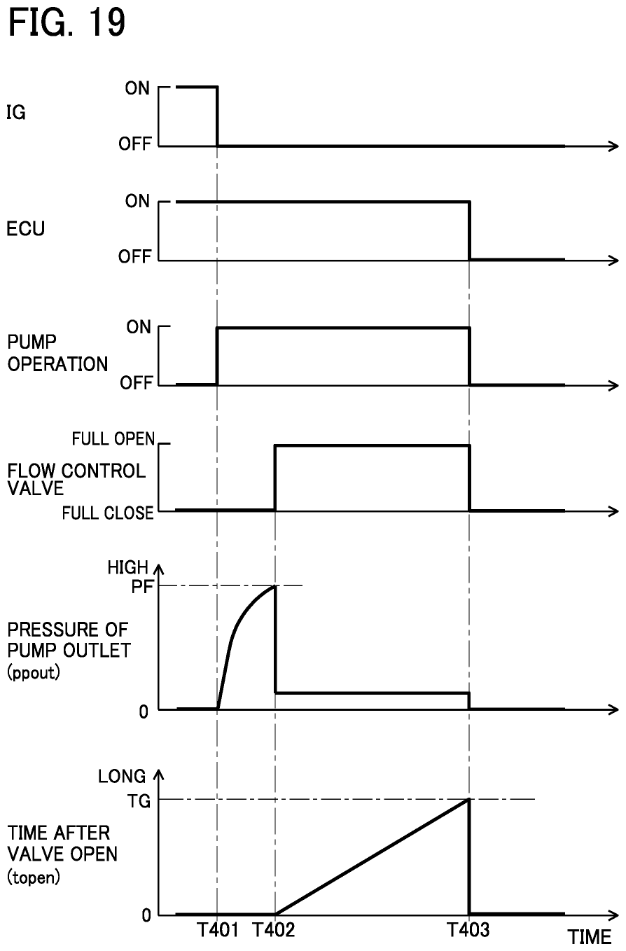

By executing a control based on the above control flowchart, a control represented as a control time chart shown in FIG. 19 is carried out.

As shown in FIG. 19, in time T401, the ignition switch turns “OFF”, and the air pump 12 is operated (denoted as “ON” in a pump operation in the figure), so that the pump outlet pressure (ppout) increases from “0”.

Subsequently, in time T402, the pump outlet pressure (ppout) reaches the predetermined pressure PF, and thus the flow control valve 14 is switched to the valve-opening state (denoted as “full-open” in the figure) from the valve-closing state (denoted as “full-close” in the figure).

Subsequently, in time T403 when the predetermined time TG has elapsed from time T402, namely, the time after valve-opening of the flow control valve (topen) reaches the predetermined time TG, the air pump 12 is halted and the flow control valve 14 is switched from the valve-opening state to the valve-closing state, thereby the ECU being turned “OFF”.

### <Effects and Operations of Present Embodiment>

As mentioned above, according to the present embodiment, the control unit 15 brings the flow control valve 14 into the valve-closing state and operates the air pump 12 for a predetermined time during halt of the engine 41 in which the ignition switch is “OFF”, and thereafter, the flow control valve 14 is brought into the valve-opening state.

As mentioned above, the flow control valve 14 is brought in the valve-closing state and the air pump 12 is operated for a predetermined time to increase the pump outlet pressure (ppout), and then the flow control valve 14 is brought in the valve-opening state. Thus, the condensed water residing in the frozen portions of the fin 23 and the surroundings of the fin 23 can be scattered to a secondary air passage 13 (see FIG. 1) on a downstream side of the flow control valve 14 by an impulse flow of the air. Accordingly, during halt of the engine 41, the condensed water can be scavenged from the air pump 12, thereby preventing freeze of the fin 23 and the surroundings of the fin 23 in the air pump 12 due to the condensed water.

The above-mentioned embodiments are only illustration and the present disclosure is not limited to those and may be applied with various improvements and modifications without departing from the scope of its subject matter.

For example, as one example of a “flow rate pump” of the present disclosure, a purge pump controlling a flow rate of purge gas may be adopted.

In the above aspect, preferably, the fluid pump control unit is configured not to rotate a rotor of the motor when performing the energization switching control for unfreezing.

According to this aspect, the energization switching control for unfreezing is carried out in a state where the rotor is halted, and thus the fluid pump can be unfrozen with restraining the load subjected to the connecting portions between the rotary shaft connected to the rotor and the fin connected to the rotary shaft in the fluid pump. Accordingly, the fluid pump can be unfrozen with maintaining the endurability of the fluid pump.

In the above aspect, preferably, the fluid pump control unit is configured to vary at least any of the energization time and the non-energization time to the coil according to the number of times for switching energization and non-energization that is the number of times for switching the energization and the non-energization to the coil since start of the energization switching control for unfreezing.

According to this aspect, repetition of energizing the coil can prevent gradual rise in the coil temperature due to remaining heat generated after the coil energization. Accordingly, the coil temperature can be prevented from exceeding its allowable temperature.

In the above aspect, preferably, the fluid pump control unit is configured to shorten the energization time to the coil as the number of times for switching the energization and the non-energization increases.

According to this aspect, the coil temperature can be restrained from gradual rise due to the remaining heat generated after the coil energization as the number of times for switching the energization and the non-energization increases. Accordingly, the coil temperature can be further surely prevented from exceeding the allowable temperature.

In the above aspect, preferably, the fluid pump control unit is configured to extend the non-energization time to the coil as the number of times for switching the energization and the non-energization increases.

According to this aspect, even if the coil temperature is once increased due to the remaining heat after the coil energization, the coil temperature decreases at the non-energization time to the coil, thus restraining gradual rise in the coil temperature irrespective of the increasing number of times for switching the energization and the non-energization. Accordingly, it is possible to further surely prevent the coil temperature from exceeding the allowable temperature.

In the above aspect, preferably, the fluid pump control unit is configured to vary at least any one of the energization time and the non-energization time to the coil according to an outside air temperature.

According to this aspect, irrespective of the outside air temperature, it is possible to stably restrain gradual rise in the coil temperature due to the remaining heat generated after the coil energization that is repetitively performed. Accordingly, it is possible to prevent the coil temperature from exceeding the allowable temperature irrespective of the outside air temperature.

In the above aspect, preferably, the fluid pump control unit is configured to extend the energization time to the coil as the outside air temperature decreases.

According to this aspect, even when the outside air temperature is low, extension of the energization time to the coil enables increase in the coil temperature to the target temperature in a short time. Accordingly, the fluid pump can be quickly unfrozen even when the outside air temperature is low.

In the above aspect, preferably, the fluid pump control unit is configured to shorten the non-energization time to the coil as the outside air temperature decreases.

According to this aspect, the non-energization time to the coil is shortened even when the outside air temperature is low, and thereby the coil temperature can be increased to the target temperature in a short time. Accordingly, the fluid pump can be quickly unfrozen even when the outside air temperature is low.

Another aspect of the present disclosure made for solving the above problem is a fluid pump control unit comprising a motor, wherein the control unit is configured to perform a continuous energization control for unfreezing of continuously energizing a coil of the motor to unfreeze the fluid pump when the fluid pump is determined to be frozen, and the control unit is configured to gradually reduce a supply power to the coil with lapse of time when performing the continuous energization control for unfreezing.

According to this aspect, when the fluid pump is to be unfrozen during the frozen determination of the fluid pump, the supply power to the coil is not constant but gradually reduced with the lapse of time. In this manner, the coil temperature can be increased in a short time to the target temperature less than an allowable temperature of the coil and the thus increased temperature can be maintained by appropriately supplying (applying) the power (current or voltage) to the coil to energize the coil in consideration with the allowable temperature. Accordingly, the temperature of frozen portions (for example, a fin and surroundings of the fin) of the fluid pump is increased in a short time by the heat transferred from the coil, thus unfreezing the frozen portions in a short time. Therefore, the fluid pump can be unfrozen quickly.

In the above aspect, preferably, the fluid pump control unit is configured not to rotate the rotor of the motor when performing the continuous energization control for unfreezing.

According to this aspect, the continuous energization control for unfreezing is performed during halt of the rotor, so that the fluid pump can be unfrozen with restraining the load subjected to connecting portions between the rotary shaft connected to the rotor and the fin connected to the rotary shaft in the fluid pump. Accordingly, the fluid pump can be unfrozen with maintaining the endurability of the fluid pump.

In the above aspect, preferably, the fluid pump control unit is configured to control a gradual decrease rate of power that is a ratio of gradually reducing the supply power with the lapse of time based on an outside air temperature.

According to this aspect, irrespective of the outside air temperature, the coil temperature can be increased to a target temperature in a short time by energizing the coil. Accordingly, the fluid pump can be quickly unfrozen irrespective of the outside air temperature.

In the above aspect, preferably, the fluid pump control unit is configured to lessen the gradual decrease rate of power as the outside air temperature decreases.

According to this aspect, the gradual decrease rate of the power is low even when the outside air temperature is low, and thus the coil temperature can be increased to the target temperature in a short time by energizing the coil. Accordingly, the fluid pump can be further reliably unfrozen in a short time irrespective of the outside air temperature.

In the above aspect, preferably, the fluid pump control unit is configured to perform any one of the energization switching control for unfreezing and the continuous energization control for unfreezing for a first predetermined time, to subsequently halt the fluid pump for a second predetermined time and then operate the fluid pump.

According to this aspect, after the energization switching control for unfreezing or the continuous energization control for unfreezing is performed to unfreeze the fluid pump, the fluid pump is not directly operated but suspended for a predetermined time before operation. Thereby, even in a case where ice flakes exist in the unfrozen portion (for example, frozen portions of the fin and the surroundings of the fin) of the fluid pump when the energization switching control for unfreezing or the continuous energization control for unfreezing is performed to unfreeze the fluid pump, the fluid pump can be operated after the ice flakes are completely unfrozen. Accordingly, during operation of the fluid pump, the ice flakes existing in the unfrozen portion of the fluid pump are prevented from abutting or crashing on an operation part (such as the fin), and thus the endurability of the fluid pump can be refrained from degradation. Consequently, the fluid pump can be operated with maintaining the endurability to discharge and scavenge condensed water that is generated after unfreezing.

In the above aspect, preferably, the fluid pump control unit is configured to control at least any one of the first predetermined time and the second predetermined time based on the outside air temperature.

According to this aspect, irrespective of the outside air temperature, the fluid pump can be operated after the ice flakes existing in the unfrozen portion of the fluid pump is completely unfrozen. Therefore, irrespective of the outside air temperature, the ice flakes existing in the fluid pump are prevented from abutting or crashing on the operation part, and thus the endurability of the fluid pump can be refrained from degradation.

In the above aspect, preferably, the fluid pump control unit is configured to extend at least any one of the first predetermined time and the second predetermined time as the outside air temperature decreases.

According to this aspect, even when the outside air temperature is low, the fluid pump can be operated after the ice flakes existing in the unfrozen portion of the fluid pump is completely unfrozen. Accordingly, even when the outside air temperature is low, the ice flakes existing in the unfrozen portion of the fluid pump is prevented from abutting or crashing on the operation part during operation of the fluid pump, and thus the endurability of the fluid pump can be restrained from degradation.

In the above aspect, preferably, the fluid pump control unit is configured to bring a flow control valve provided on a downstream side of the fluid pump into a valve-closing state during halt of an internal combustion engine and to operate the fluid pump for a predetermined time, and to subsequently bring the flow control valve into a valve-opening state.

According to this aspect, the flow control valve is set in the valve-closing state and the fluid pump is operated for a predetermined term so that the pressure on a downstream side of the fluid pump is increased, and then, the flow control valve is set in the valve-opening state. Thus, condensed water residing in the unfrozen portion (for example, the unfrozen portions of the fin and the surroundings of the fin) of the fluid pump can be scattered to a downstream side of the flow control valve by an impulse flow of the air. Accordingly, during halt of the internal combustion engine, the condensed water can be scavenged from the fluid pump, thus preventing freezing of the fluid pump due to the condensed water.

### REFERENCE SIGNS LIST

1 Secondary air supply apparatus

11 Filter

12 Air pump

13 Secondary air passage

14 Flow control valve

15 Control unit

21 Motor

22 Rotary shaft

23 Fin

31 Rotor

32 Core

33 Coil

41 Engine

42 Exhaust passage

43 Catalyst

sthw Startup water temperature

stha Startup outside air temperature

TA Predetermined temperature

tpoff Elapsed time after halt coil energization

prpm Pump rotation speed

RA Predetermined rotation speed

tpon Elapsed time after coil energization

An Predetermined time

Bn Predetermined time

X waiting Unfreeze waiting flag

tpwaiting Waiting time after unfreeze

TC Predetermined time

TD Predetermined time

TX Predetermined time

TY Predetermined time

En Predetermined time

TG Predetermined time

What is claimed is:

1. A fluid pump control unit comprising a motor, wherein
the control unit is configured to perform an energization switching control for unfreezing of switching energization and non-energization of the motor to the coil to unfreeze the fluid pump when the fluid pump has been determined to be frozen, and
the control unit is configured to vary at least any one of an energization time and a non-energization time to the coil when performing the energization switching control for unfreezing.

2. The fluid pump control unit according to claim 1 is configured not to rotate a rotor of the motor when performing the energization switching control for unfreezing.

3. The fluid pump control unit according to claim 1 is configured to vary at least any of the energization time and the non-energization time to the coil according to the number of times for switching energization and non-energization that is the number of times for switching the energization and the non-energization to the coil since start of the energization switching control for unfreezing.

4. The fluid pump control unit according to claim 3 is configured to shorten the energization time to the coil as the number of times for switching the energization and the non-energization increases.

5. The fluid pump control unit according to claim 3 is configured to extend the non-energization time to the coil as the number of times for switching the energization and the non-energization increases.

6. The fluid pump control unit according to claim 1 is configured to vary at least any one of the energization time and the non-energization time to the coil according to an outside air temperature.

7. The fluid pump control unit according to claim 6 is configured to extend the energization time to the coil as the outside air temperature decreases.

8. The fluid pump control unit according to claim 6 is configured to shorten the non-energization time to the coil as the outside air temperature decreases.

9. A fluid pump control unit comprising a motor, wherein
the control unit is configured to perform a continuous energization control for unfreezing of continuously energizing a coil of the motor to unfreeze the fluid pump when the fluid pump is determined to be frozen, and
the control unit is configured to gradually reduce a supply power to the coil with lapse of time when performing the continuous energization control for unfreezing.

10. The fluid pump control unit according to claim 9 is configured not to rotate the rotor of the motor when performing the continuous energization control for unfreezing.

11. The fluid pump control unit according to claim 9 is configured to control a gradual decrease rate of power that is a ratio of gradually reducing the supply power with the lapse of time based on an outside air temperature.

12. The fluid pump control unit according to claim 11 is configured to lessen the gradual decrease rate of power as the outside air temperature decreases.

13. The fluid pump control unit according to claim 1 is configured to perform any one of the energization switching control for unfreezing and the continuous energization control for unfreezing for a first predetermined time, to subsequently halt the fluid pump for a second predetermined time and then operate the fluid pump.

14. The fluid pump control unit according to claim 13 is configured to control at least any one of the first predetermined time and the second predetermined time based on the outside air temperature.

15. The fluid pump control unit according to claim 14 is configured to extend at least any one of the first predetermined time and the second predetermined time as the outside air temperature decreases.

16. The fluid pump control unit according to claim 1 is configured to bring a flow control valve provided on a downstream side of the fluid pump into a valve-closing state during halt of an internal combustion engine and to operate the fluid pump for a predetermined time, and to subsequently bring the flow control valve into a valve-opening state.

17. The fluid pump control unit according to claim 9 is configured to perform any one of the energization switching control for unfreezing and the continuous energization control for unfreezing for a first predetermined time, to subsequently halt the fluid pump for a second predetermined time and then operate the fluid pump.

18. The fluid pump control unit according to claim 17 is configured to control at least any one of the first predetermined time and the second predetermined time based on the outside air temperature.

19. The fluid pump control unit according to claim 18 is configured to extend at least any one of the first predetermined time and the second predetermined time as the outside air temperature decreases.

20. The fluid pump control unit according to claim 9 is configured to bring a flow control valve provided on a downstream side of the fluid pump into a valve-closing state during halt of an internal combustion engine and to operate the fluid pump for a predetermined time, and to subsequently bring the flow control valve into a valve-opening state.
